(19) United States
(12) Patent Application Publication
(10) Pub. No.: US 2005/0256606 A1
(43) Pub. Date: Nov. 17, 2005

(54) Method in the control of a machine tool cell

(76) Inventors: Antero Irri, Vilppula (FI); Martti Vaisanen, Ylistaro (FI)

Correspondence Address: LOUIS WOO;LAW OFFICE OF LOUIS WOO, 717 NORTH FAYETTE STREET, ALEXANDRIA, VA, 22314, US

(21) Appl. No.: 10/517,649

(22) PCT Filed: Jun. 12, 2003
(86) PCT No.: PCT/FI03/00464

§ 371 Date: Jun. 9, 2005

(30) Foreign Application Priority Data
Jun. 14, 2002 (FI) 20021155

(51) Int. Cl. G06F 7/00

(52) U.S. Cl. 700/213

(57) ABSTRACT

The invention relates to a method for controlling a machine tool cell consisting of a press brake (6) and one or more robots (9) serving the same. According to the invention, the data needed for designing the movement plan (200), or the like, for the robot (9) is collected in connection with designing the bending program (100) for the press brake (6), and said data is automatically compiled to a bend line table (BLT), which table indicates, for bendings to which a sheet is subjected in the press brake (6), the bend lines and their locations and positions in a coordinate system (X, Y, Z), whose origin is the sheet centre (AKP) of the sheet to be machined. Said bend line table (BLT) is further set to be used as a variable in movement programs (200) for one or more robots (9) serving the press brake (6). When the bending program (100) of the press brake (6) is changed for a new product, it is also easy and fast, by means of the invention, to generate a new movement program (200) of the robot (9) for the new product.

The invention relates to a method according to the preamble of claim 1 for controlling a machine tool cell consisting of a press brake and one or more robots serving the same.

In modern industrial production, various automated machine tool cells are very widely used, in which a worker working at a machine tool has been replaced with one or more industrial robots. In these unmanned robot cells, the robot, for example, transfers a sheet from a sheet feeding storage to a machining station, to be machined by the machine tool, moves the object to be machined in a controlled manner in the machining station, if necessary, as the machining proceeds, and after the machining, moves the sheet from the machining station aside to a starting position, for example on a pallet. The sheet to be machined may be, for example, of a raw material yet unprocessed, or a semi-product already partly processed.

One example of such a robotized machine tool cell is the functional unit consisting of a press brake and an industrial robot serving the same. A press brake is a machine tool in which different bendings and shapes can be produced in typically sheet-like objects between bending tools (upper tool and lower tool) pressed against each other. The largest press brakes may have a pressing force in the order of hundreds of tons and a bending length of several metres. Smaller press brakes, in turn, are suitable for machining various thin sheet structures of lighter weight. An industrial robot serving a press brake has the essential function of moving the sheet to be machined between the bending tools of the press brake between the bendings performed by the press brake, so that the desired shapes can be bent at the desired locations in the sheet. For this reason, the functions of both the press brake and the robot must be precisely coordinated.

Modern press brakes are numerically controlled (NC) machines, wherein the machine tool executes its work routine according to a bending program input in it. In a corresponding manner, the industrial robots are also controlled by software; that is, the instructions of the robot are determined according to the movement program of the robot.

One of the most important requirements for the profitable robotization of press brake cells is that products are manufactured in relatively large series in the automated machine tool cell. For small batches, the robotization is not economically viable. One significant reason for this is that in addition to designing a bending program for the press brake, the automated cell also requires separate programming for the movement program of the robot serving the press brake. The programming of the robot is laborious and time consuming, wherein it is not economically viable for small production runs. Furthermore, the design of the movement program for the robot is complicated by the fact that the program of movements must be fitted to match precisely the bending program executed by the press brake, so that the object would be machined correctly and without extra delays. Nowadays, the bending program required by the press brake can already be designed in a relatively efficient manner by using arrangements known as such.

For the programming of industrial robots to serve press brakes, various ways are known from prior art, which will be briefly discussed in the following.

An industrial robot can be taught the required paths by using the robot's own programming language; in other words, the user writes manually the movement program for the robot. However, this is relatively time consuming, and the production cell is out of production use during the programming of the robot and during the testing of the compatibility of the program designed for the robot and the functions implemented by the press brake in its bending program. The manual programming of the robot also requires that the user has relatively good knowledge and professional skills in the programming properties of the robot, which has a direct effect on the labour costs.

A method is also known from prior art, in which the robot is taught its paths by “leading” an actuator, e.g. a gripper, of the robot, wherein the control instructions corresponding to these paths are stored in the memory of the controller of the robot. Also when operating in this way, the production cell is out of production use during the programming. Furthermore, when this method is applied, the coordination between programs of the machine tool and the robot serving the same becomes difficult. Moreover, in the case of massive industrial robots and heavy pieces manipulated by them, this is often physically impossible to do in practice. The path of the robot can be stored in a memory by controlling the robot manually by control buttons or the like, but in this case, the path of the robot tends to become angular, because it is difficult to control the simultaneous movements of several axes.

In a known manner, the programming of the robot can also be implemented by so-called remote programming by a personal computer or a corresponding work station. In the remote programming, the robot is programmed in a graphical and simulated manner on the display of a personal computer, wherein the functions of the robot generated by the program designed in this way can also be tested by simulation before the program is introduced in actual production use. Naturally, the remote programming has the advantage that the production cell can be kept in production use also during the designing of a movement program for the robot, required for a new product. However, because of their complexity, good and functional remote programming software suitable for press brakes are relatively expensive. Also, programming of the robot by remote programming can be considered almost as demanding as direct manual programming of the robot by using its own programming language, wherein the need for trained and expensive personnel will be necessary. Furthermore, the later manual editing of a movement program designed for a robot by remote programming is almost impossible in practice, because the source-language program formed “by machine” in the simulation has a complex logical structure, and its detailed instructions and operations can thus not be easily perceived by a programmer.

In principle, it would also be possible to develop a separate, common control language for the machine tool and the robot, so that, for example, both the bending program of the press brake and the movement program of the robot serving the same could be written simultaneously as a single entity. However, this would require a relatively uniform implementation of the numerical controls and software in the press brake and the robot, to make these devices sufficiently similar in view of programming. However, as the manufacturers of e.g. press brakes and industrial robots are, in practice, different parties, this solution cannot be easily implemented without extensive standardization. In view of the costs and time consumption, this is not reasonable in the present situation.

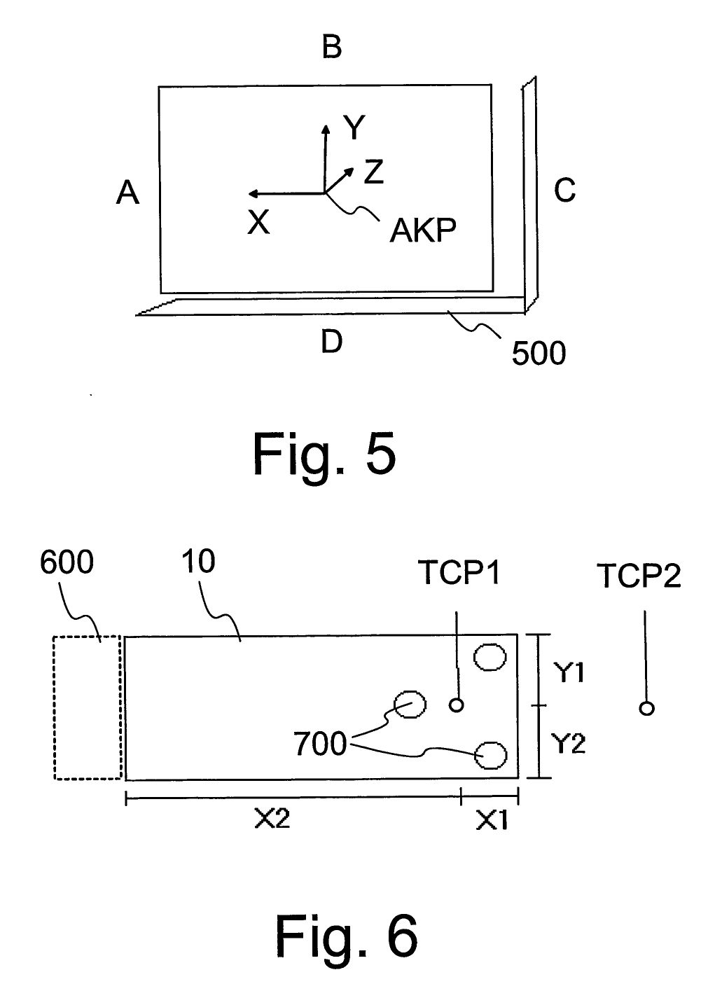

Japanese patent publication JP 03146225 A discloses an arrangement, by which the bending program of a press brake and the movement program of an industrial robot serving the same are both designed on the basis of common work data to be designed for a sheet to be machined. An operator designs this work data to be written in a particular data format by selecting, from predetermined basic templates, suitable templates which represent bendings. After this, in the basic templates, the operator defines, for each angle, the angle type, bending gradient, and the distances between the angles according to the piece to be produced. These optional basic templates are presented more closely in FIGS. 5 and 6 of the patent document JP 03146225 A. In addition, the operator defines an order for machining the angles and, if necessary, gives additional attributes of machining methods and, for example, material strengths.

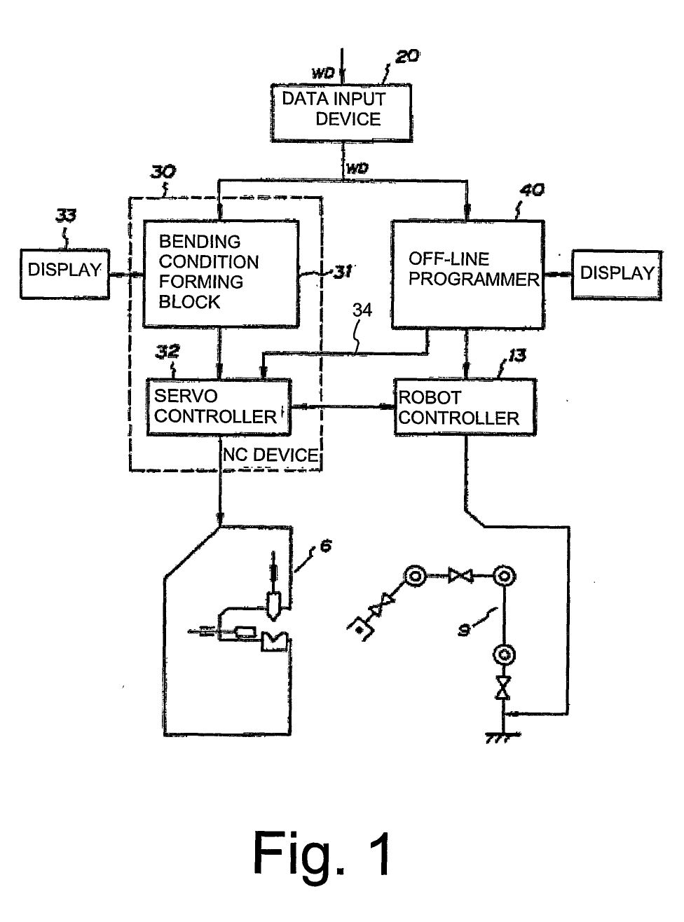

In the appended FIG. 1, which corresponds to FIG. 1 of the patent document JP 03146225 A, equipped with text translations, block 20 illustrates the entering of said work data WD into a data processor used as a data input device. From block 20, the work data WD is conveyed further to block 30 for designing a bending program for a press brake 6 in a bending condition forming block 31, and separately to a program forming block 40 for designing a movement program for a robot 9. The programs thus formed are input further in a servo controller 32 for the brake press and in a controller 13 for the robot. To coordinate the functions of the press brake 6 and the robot 9, the program forming block 40 for the robot and the servo controller 32 for the press brake are arranged in a data transmission connection 34 with each other, wherein if the program run by the press brake 6 exceeds the speed of the functions of the robot 9, the running of the program of the press brake 6 can be slowed down in the servo controller 32, if necessary.

Although the arrangement presented in the patent document JP 03146225 A makes it easier to design the bending program for the press brake and the movement program for the robot, the arrangement is still, in its essential elements, based on the fact that the designing of the bending program and the movement program is based on utilizing common work data WD set up in a special format. In practice, the design of such work data involves significant limitations and extra work.

It is the main aim of the present invention to present a totally new method for designing the movement program for one or more robots serving a press brake, to avoid the above-described problems of prior art. The invention is intended for rationalizing the programming of the robot in such a way that, in the case of a robotized press brake cell, also substantially smaller production runs become economically viable. It is thus a particular aim of the invention to develop the programming of the robot in such a way that the time required for programming for a new product can be substantially reduced.

To attain these purposes, the method according to the invention is primarily characterized in what will be presented in the characterizing part of claim 1.

What is essential in the background of the invention is the principle that it is appropriate to describe the operations required in the manufacture of the product particularly by utilizing the functions of the press brake and the programming procedure. The press brake can be considered the primary device in said press brake cell, whose function (bending program) should be primarily optimized and which the serving industrial robot must be subjected to. In the design of the bending program for the press brake, the bendings which the product is subjected to, are automatically arranged e.g. in an optimal bending order, i.e., the order in which the bendings of the sheet are fastest and most practical to perform.

Thus, both the design of separate work data, common to both the press brake and the robot, according prior art (JP 03146225 A) is not reasonable in view of either the time consumption and the optimal operation of the press brake. Similarly, it is not reasonable to develop a totally new programming language or programming environment common to both the press brake and the robot.

Consequently, in essence, the basic idea of the present invention is that the movement program for the robot to serve the press brake is designed automatically on the basis of the data input for the bending program of the press brake and the bending order to be defined and optimized for the bending program. It is thus possible that the person responsible for the press brake cell substantially needs to master the programming of the press brake only. By means of the invention, the movement program of the robot is generated automatically in connection with the programming of the press brake, wherein the programming time needed for a new product becomes shorter and the production becomes more rationalized, accordingly. Thus, the separate programming required by the robot is thus substantially eliminated.

Thus, the invention makes it possible, for example, that a press brake cell which has previously been assisted/operated by a worker can be, in view of programming, easily converted to a robotized cell, because the programming of the cell needed for new products will not be substantially changed in practice. Changes in products will substantially require re-programming of the press brake only, and the movement programs required by a robot are generated automatically on the basis of this.

The invention is based on the idea that in the design of the bending program of the press brake, substantially all the data needed for generating the movement program for the robot is already available. According to the invention, this data is collected in connection with the design of the bending program for the press brake and is transferred in a suitable format further to be used in the movement program of the robot, wherein the robot automatically implements the path of movements, by which the object can be subjected to the bendings according to the bending program. Thus, the movement program of the robot can also be easily synchronized with the bending program of the press brake. A significant advantage of the invention is that because the bending program defines an optimal order of bendings which the sheet is to be subjected to, this information is automatically transferred to the movement program of the robot as well.

When the bending program of the press brake is changed for a new product in the press brake cell formed by the press brake and the robot, it is also easy and fast, by means of the invention, to generate the new movement program of the robot for the new product.

According to the invention, the data needed for the movement program of the robot are compiled in a so-called bend line table BLT, which indicates, for the bendings of a sheet to be machined in the press brake, the bend lines and their locations and positions in a coordinate system whose origin is the centre of the sheet. This bend line table is further set to be used as a variable in movement programs for one or more robots serving the press brake. When the data contained in the bend line table is updated as the bending program is changed, the changes are thus automatically transferred to be used in the movement program as well.

In an advantageous embodiment of the invention, in the design of the movement program of the robot, the points of gripping by the robot on the sheet to be machined are defined on the basis of data included in the bend line table, to subject the sheet to as many successive bendings as possible by one grip, without changing the grip by the robot. This will substantially accelerate the operation of the production cell in production use and thereby improve the cost-effectiveness of the production.

Thanks to the invention, there is no need to acquire expensive programs needed for remote programming of the robot, or to train the users of the robotized press brake cell for various programming and operating environments. The operator will substantially need to know only the programming of the press brake, and the programs required by the robot can be generated automatically on the basis of the bending program made for the press brake.

The invention also makes it possible to assemble a robotized press brake cell of a press brake and an industrial robot which is always most suitable for the purpose in question. In different applications, the robot type to serve the same press brake can be selected in different ways without a need for the operators to particularly study the programming ways related to the robot in question.

The invention and the advantages of its various embodiments will be better understood by a person skilled in the art from the following, more detailed description. In the description, reference will be made to the appended drawings, in which

FIG. 1 shows an arrangement of prior art in the programming of a press brake cell,

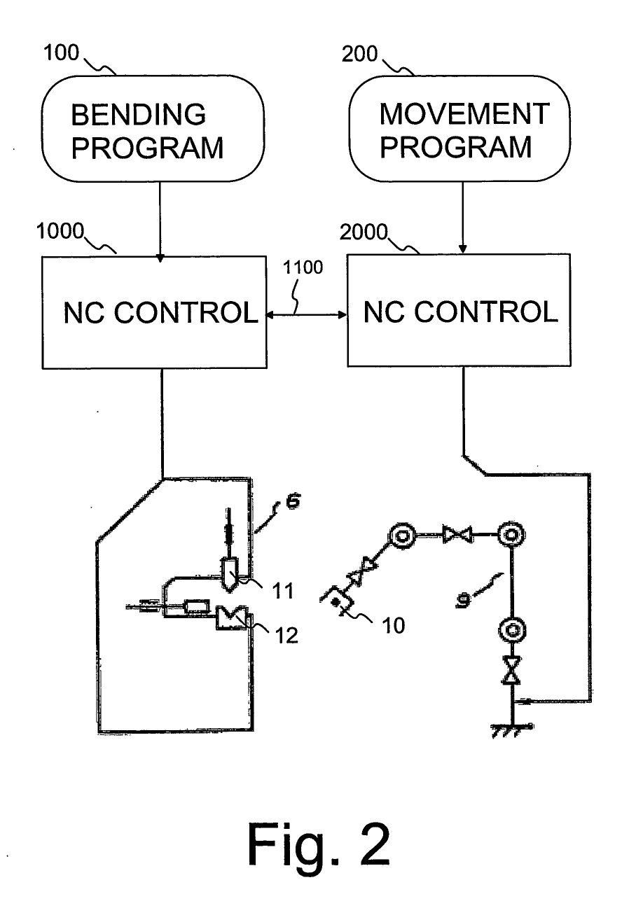

FIG. 2 shows, in a principle view, a press brake cell consisting of a numerically controlled press brake and a numerically controlled robot,

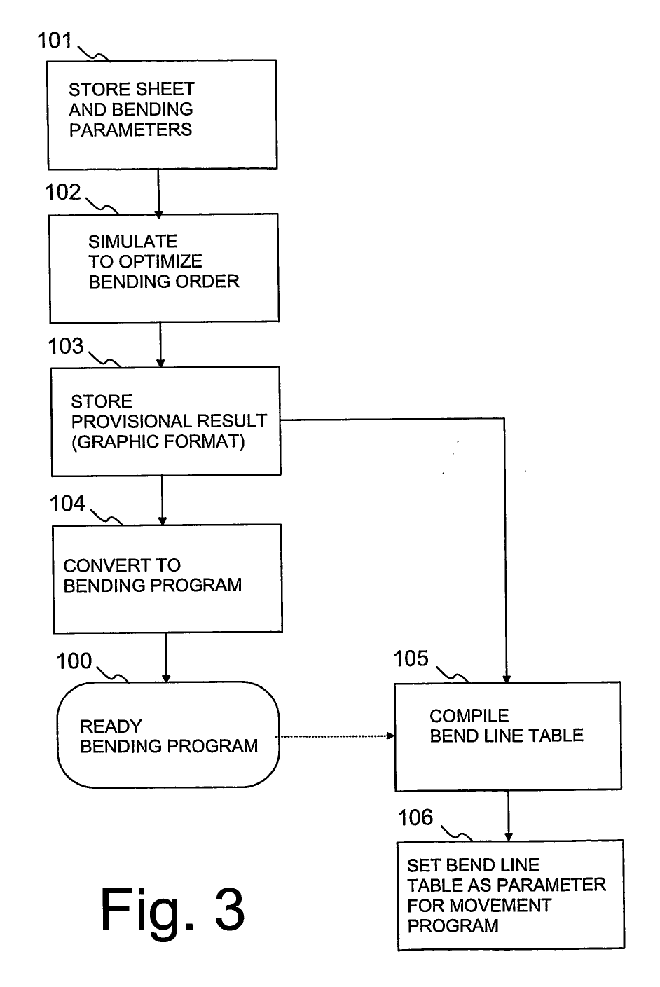

FIG. 3 shows, in a principle block chart, the designing of a movement program for a press brake and the concurrent compilation of a bend line table according to the invention,

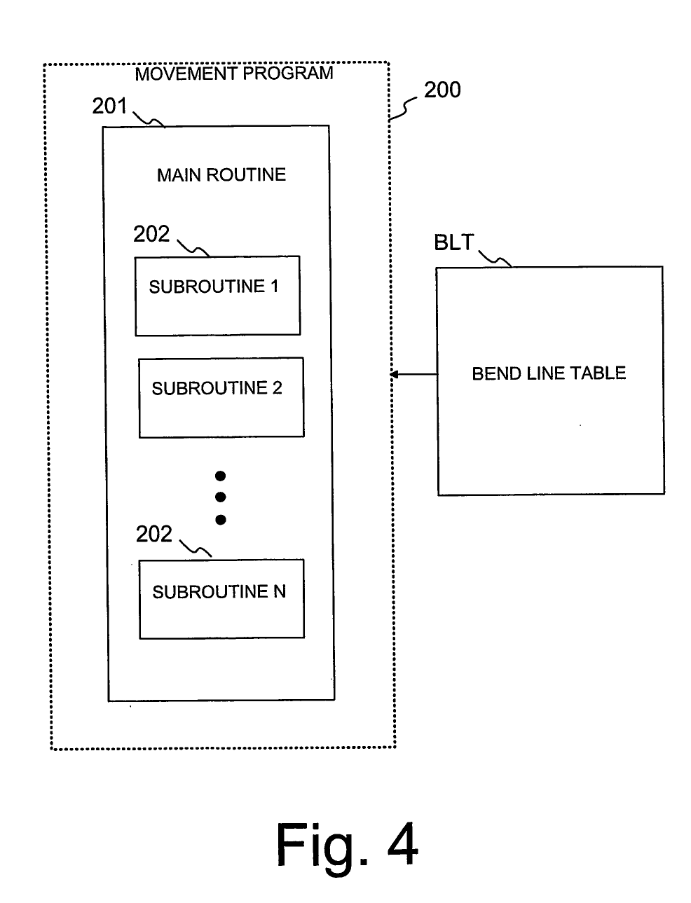

FIG. 4 shows, in a principle block chart, the structure of a movement program for a robot according to the invention, as well as the setting of a bend line table as a variable in the movement program,

FIG. 5 shows, in a principle view, a planar sheet on a centering table as well as a coordinate system according to the invention, and

FIG. 6 shows, in a principle view, a gripper of a robot, its dimensions, and some possible locations of a tool point.

FIG. 1 has already been discussed above in connection with the description of prior art.

FIG. 2 shows, in principle, a robotized press brake cell, including a numerically controlled press brake 6 and a robot 9 serving the same. The press brake 6 comprises, as essential parts, an upper tool 11 and a lower tool 12. The robot 9 is equipped with a gripper 10. The numerical control 1000 of the press brake 6 and the numerical control 2000 of the robot 9 are arranged in a data transmission connection 1100, by means of which the execution of the bending program 100 and the movement program 200 in said numerical controls 1000, 2000 can be synchronized in time.

To design the bending program 100, the following steps 101-104 are taken, which are shown in a principle block chart in FIG. 3.

The first step 101 is to store sheet parameters representing the material, original dimensions or other properties of the sheet to be machined, as well as bending parameters representing the bendings to which the sheet is to be subjected in the press brake 6.

In the second step 102, the sheet and bending parameters stored in the first step 101 are utilized to define the bending order, i.e. the optimized order of bendings of the sheet in the press brake 6, by simulating the bending procedure or in a corresponding manner.

In the third step 103, the data obtained from the first 101 and second 102 steps is stored as a provisional result in a data format which is preferably selected to be such that the bending procedure can be graphically displayed by a computer, or the like.

In the fourth step 104, the provisional result stored in the third step is converted to an actual bending program 100 for the press brake 6, to be executed in the numerical control 1000 of the press brake 6, or the like.

The above-mentioned steps 101 to 104 can be taken, in a way known as such, either by remote programming in a separate PC or in another data processor in which the data relating to the sheet (sheet parameters and bending parameters) have been input manually, or said data has been transferred, for example, in digital format directly from a computer aided design (CAD) for the object.

The steps 101 to 104 can also be taken in a sufficiently sophisticated numerical control 1000 for a press brake, such as, for example, Delem DA-69 control (Delem, the Netherlands). Said control type is capable of simulating the bendings to which the piece is to be subjected, on the basis of sheet parameters and bending parameters input in or transferred to the control. In the simulation, the optimal bending order is defined with the assistance of the operator, and the results of the simulation are stored as a provisional result in a data file which is suitable to be displayed graphically on the display of the numerical control 1000. By using this provisional result, the numerical control generates the final bending program 100.

According to the present invention, the data required for generating the movement program of the robot 9 is automatically collected in connection with the above-presented steps 101 to 104 and transferred further in a suitable format to be used in the movement program of the robot 9.

To put it more precisely, the procedure is such that, in the fifth step 105 in the figure, the provisional result of the third step 103 and/or the bending program 100 of the fourth step 104 are analyzed automatically, and on the basis of this analysis, a bend line table BLT is compiled, which bend line table indicates, for the bendings to which the sheet is subjected in the press brake 6, the bend lines and their locations and positions in a coordinate system whose origin is the centre of the sheet. In the sixth step 106, the bend line table is further set to be used as a variable in the movement programs 200 of one or more robots 9 serving the press brake 6.

A single bend line refers to the line of the sheet/piece to be machined, which line is placed to be parallel with the elongated bending tools 11, 12 of the press brake and further between them, and along which bending line the object is bent in a desired manner, being pressed by the bending tools 11, 12.

Because the sheet to be machined by the press brake 6 can have a relatively asymmetrical shape, a so-called sheet square is preferably defined for the sheet, referring to the smallest possible two-dimensional quadrangle, inside which the sheet fits. The centre of this sheet square, the sheet centre, is used as the origin for the coordinate system to be used in connection with the two-dimensional bend line table. This coordinate system is used, for example, to determine the locations of the bend lines for the bendings to which the sheet is subjected, as well as the locations of the gripping points used by the robot 9 when gripping the sheet.

FIG. 5 shows, in a principle view, a planar sheet on a centering table 500, which can be used to determine the location of the first gripping point of the robot 9 in relation to the outer dimensions of the sheet in a way known as such. FIG. 5 also shows the sheet centre AKP according to the invention. The positive X-axis of the coordinate system used in the design of the bend line table extends towards side A from the sheet centre AKP, and the positive Y-axis extends, in a corresponding manner, towards side B from the sheet centre AKP.

The bend line table indicates the measurement and angular values about where and in which position each bend line is located in said coordinate system, whose origin is the sheet centre AKP.

The bend line table preferably gives the following data of each successive bend line in the bending order:
1. distance between the sheet center AKP and the centre of said bend line in the X-direction,
2. distance between the sheet center AKP and the centre of said bend line in the Y-direction,
3. length of said bend line,
4. length of the edge to be bent,
5. angle to be bent,
6. side (A, B, C or D) of the sheet square, which is subjected to said bending,
7. rotation of said bend line around the Z-axis (asymmetrical bending or polygonal piece),
8. position in the direction of the tools 11, 12 of the press brake 6, to which the centre of said bend line should be brought.

Consequently, the bend line table is, for example, an 8×10 matrix, in which the horizontal lines (8 lines) represent data according to the above-described points 1 to 8, and the vertical columns (10 columns) represent different bendings which the sheet is sequentially subjected to. Naturally, the size of the matrix may also be different, depending on the data and the number of successive bendings to be covered by the bend line table BLT at a time.

FIG. 4 shows, in a principle block chart, the structure of a movement program 200 for a robot according to the invention, as well as the setting of the movement program 200 as a variable in the bend line table. The movement program 200 preferably comprises a sheet-specific main routine 201, which further comprises one or more subroutines 202.

In the following, we shall describe some subroutines 202 essential for the invention, as well as the operations executed by them, in more detail.

Grip Subroutine

FIG. 6 shows, in a principle view, a gripper 10 to be fixed to the wrist 600 of the arm of a robot, its dimensions, as well as some possible locations TCP1, TCP2 of a so-called tool point defined for the gripper 10. The gripper 10 is typically equipped with suction pads 700 to get a hold of the sheet.

The grip subroutine uses the data input in the system about the dimensions X1, X2, Y2, Y1 of the gripper 10 and the location TCP1 of the tool point used when the sheet is gripped, as well as data in the bend line table, to compute how many bendings can be made with one specific grip of robot 9.

The grip is defined as a situation in which the tool point TCP1 is transferred, in the coordinate system shown in FIG. 5, to a given gripping point, in which the sheet is further picked up to a grip by the gripper 10.

The grip subroutine examines whether the gripper 10 will, by a specific grip, i.e. by a given placement of the gripping point, hit a bend line or an extension of a bend line defined in the bend line table. In the grip subroutine, the gripper 10 can be “planned” in different points of the sheet in four different angles. Of the experimented gripping points, the subroutine selects to use the one by which it can make the largest number of successive bendings defined in the bend line table. As a response, the subroutine gives the selected gripping point as well as the number of successive bendings to be made with this grip.

On the basis of this information, the system makes said number of bendings, takes the sheet, for example, to a separate grip change table, defines a new gripping point to be used next and the number of bendings to be made with it, and changes the grip and makes said bendings. After each gripping, the location of the tool point TCP1 of the gripper 10 in relation to the sheet centre AKP is stored in a memory.

Positioning Subroutine

The purpose of the positioning subroutine is to transfer the bend line for the bending, to which the sheet is to be subjected next, between the tools 11, 12 of the press brake 6.

The positioning subroutine is run on the basis of data included in the bend line table. For positioning, the location of the tool point of the gripper 10 is, at first, determined again in relation to a point TCP2 outside the gripper 10, typically in front of the gripper 10 when seen from the structure of the robot 9, which point is defined to correspond to the centre of the bend line of the bending to which the sheet is subjected next. When said change is made in the coordinate system (TCP1→TCP2), the grip of the sheet by the gripper 10 remains still the same as that defined by means of the gripping point of the sheet and the tool point TCP1 in the grip subroutine.

Now, when the tool point TCP2 is transferred between the tools 11, 12 of the press brake 6, the bend line is simultaneously transferred to the correct location to perform the bending.

The information about the change in the coordinate system, from the point TCP1 to the point TCP2 and in relation to the sheet center AKP, is stored in the memory of the system. In view of the control of the robot 9, it is advantageous to define the location of the tool point TCP2 in the centre of the bend line for the time of the positioning as described above, because said tool point TCP2 can thus be used directly to instruct the robot to transfer the bend line to the correct location for the bending by the press brake 6.

The invention is characterized in that the same positioning subroutine is always used for automatic positioning. This routine utilizes the bend line table, and the paths in this routine cannot be edited by the operator.

However, if necessary, the operator can define parameters for the positioning subroutine, which parameters are used to determine how automatically the routine is run. For example, the operator can set a condition that the robot 9 stops at a given positioning point close to the tools 11, 12 of the press brake before the sheet/bend line is introduced between said tools. Thus, if necessary, the operator can check the correct function of the movement program 200 and/or teach/fine-adjust the position of the final positioning point between the tools 11, 12.

Follow-Up Subroutine

The follow-up subroutine is responsible for the follow-up of the sheet during the bending of the bend line, or that the robot 9 moves with the sheet when it is bent by pressing between the tools 11, 12 of the press brake 6. At first, this routine stores the point where the robot 9 is positioned; this point is preferably stored in a user coordinate system created in the lower tool 12 of the press brake 6, and the coordinates of said point are given in relation to the lower tool 12 of the press brake 6. Next, the press brake 6 is given an instruction to press, and a time is waited until the press brake 6 informs that the upper tool 11 touches the sheet to be bent. After this, the actual sheet bending work movement of the press brake 6 is started.

A so-called upper beam in connection with the upper tool 11 of the press brake 6 is preferably provided with a separate position sensor, to inform the robot 9 about the position of the upper beam and the upper tool 11. On the basis of this information, the robot 9 computes a new position for the user coordinate system created in the press brake 6, lowers it down for the movement of the upper beam/upper tool, and computes how much the coordinate system has been turned. After this, the tool point of the gripper 10 of the robot 9 is moved to its original point in this changed user coordinate system. In this way, the robot 9 itself takes care of the computation of the paths, possible changes in the configurations of the position of the wrist of the robot 9, and the corresponding operations.

However, the invention is not limited solely to such embodiments in which the robot 9 holds the sheets during the bending, following the movement of the sheet as described above. One embodiment of the invention utilizes the fact that when the sheet is being gripped by the tools 11, 12 of the press brake, the position of the sheet remains known when the sheet is stationary or also when the sheet is being bent. In the latter case, the position of the sheet can be determined by means of the sensor measuring the position of the upper tool 11 in the same way as when determining the path of the robot 9 when it holds the sheets during bending. Thus, the grip of the sheet by the press brake 6 corresponds, in a way, to the function of a centering table and makes it possible that the robot 9 can now, if necessary, change its grip when the sheet is held by the press brake 6. When the grip change is made simultaneously when the press brake 6 is machining the sheet, time is saved, because the robot 9 does not need, for said operation, to transfer the sheet, for example, to a separate grip change table. The grip change can be designed automatically by using the grip subroutine, or the like, or the grip change can be defined to be made by the operator as well.

In the movement program of the robot, the main routine 201 and the subroutines 202, such as the grip, positioning and follow-up subroutines, are preferably implemented in the numerical control 2000 of the robot 9, for example by using the KAREL programming language. One suitable numerical control type for a robot is, for example, FANUC R-J3 (FANUC Robotics, Japan).

Other necessary subroutines may include, for example, picking up from a sheet pallet or a corresponding transport platform, the centering of the sheet on a centering table (FIG. 5), the detection of double sheet, and the placement of the machined sheet onto a transport platform.

In an advantageous embodiment of the method according to the invention, the steps 101 to 104 shown in FIG. 3 are arranged to be taken in the numerical control 1000 of the press brake (e.g. Delem DA-69). The numerical control 1000 of the press brake transmits the data required for compiling the bend line table as a data file to the numerical control 2000 of the robot (for example, FANUC R-J3). The numerical control of the robot is provided with software which generates the bend line table in the memory of said numerical control, and further with the robot's movement program 200 which utilizes said table in the above-described manner. However, the invention is not limited to this embodiment only, but the different steps of the method according to the invention can also be arranged to be taken in other data processors suitable for the purpose.

By combining the features of the above embodiments of the invention, it is possible to provide various embodiments of the invention which comply with the spirit of the invention. Therefore, the above-presented examples must not be interpreted as restrictive to the invention, but the embodiments of the invention can be freely varied within the scope of the inventive features presented in the claims hereinbelow.

For example, it will be obvious for a person skilled in the art that, if necessary, one press brake can be served by several robots simultaneously, for which separate movement programs can be defined according to the invention. Furthermore, one robot may also comprise several gripping means, for which gripping means the positions of the gripping points can be defined separately, if necessary.

Moreover, it is possible that the robot may release its grip during bending of the object in the press brake, for example to change the grip to be ready for the next bending. It is also possible that the performing of a single bending requires the changing of the robot's grip, in the middle of the bending, to another gripping point to finish the bending.

1. A method in the control of a press brake cell formed by a numerically controlled press brake (6) and one or more robots (9) serving the same, which method comprises at least the following steps:
a first step (101) to store sheet parameters representing the material, original dimensions or other properties of the sheet to be machined in the press brake cell, as well as bending parameters representing the bendings to which the sheet is subjected in the press brake (6),
a second step (102), in which the parameters stored in the first step (101) are utilized to define the bending order, i.e. the optimized order of bendings of the sheet in the press brake (6), by simulating the bending procedure or in a corresponding manner,
a third step (103), in which the information obtained from the first (101) and second (102) steps is stored as a provisional result in a data format which is preferably selected to make a graphic representation of the bending operation possible,
a fourth step (104), in which the provisional result stored in the third step (103) is converted to a bending program (100) for the numerical control (1000) of the press brake (6), or the like,
characterized in that the method also comprises at least:
a fifth step (105), in which the provisional result of the third step (103) and/or the bending program (100) of the fourth step (104) is analyzed to compile a bend line table (BLT), which table indicates, for the bendings to which the sheet is subjected in the press brake (6), the bend lines and their locations and positions in the coordinate system (X, Y, Z), whose origin is the sheet centre (AKP) of the sheet to be machined, and
a sixth step (106), in which the bend line table (BLT) is set to be used as a variable for movement programs (200), or the like, for one or more robots (9) serving the press brake (6), or the like.

2. The method according to claim 1, characterized in that the sheet centre (AKP) is selected to be the centre of a sheet square, which sheet square refers to the smallest possible two-dimensional quadrangle inside which the sheet to be machined fits.

3. The method according to claim 2, characterized in that the bend line table (BLT) indicates following data for each successive bend line in the bending order:
side (A, B, C, D) of the sheet square subjected to said bending.

4. The method according to claim 1, characterized in that the bend line table (BLT) indicates one or more of the following data for each successive bend line in the bending order:
distance between the sheet centre (AKP) and the centre of said bend line in the X-direction of the coordinate system (X, Y, Z),
distance between the sheet centre (AKP) and the centre of said bend line in the Y-direction of the coordinate system (X, Y, Z), length of said bend line,
length of the edge to be bent,
angle to be bent,
rotation of said bend line around the Z-axis,
position in the direction of the tools (11, 12) of the press brake (6), to which the centre of said bend line should be brought.

5. The method according to claim 1, characterized in that the total number of gripping points, or grips of the sheet by one or more robots (9) manipulating the sheet, is minimized by planning a single gripping point for the sheet in such a way that said gripping point can be preferably used to perform several successive bendings corresponding to the bend line.

6. The method according to claim 1, characterized in that when the robot (9) holds on to the sheet during the bending, the coordinate system (X, Y, Z) is transferred and/or turned along with the work movement bending the sheet, and the robot (9) is simultaneously moved in the coordinates changing in this way towards the point corresponding to the starting moment of the bending.

7. The method according to claim 6, characterized in that the transferring and/or turning during the bending of the coordinate system is determined by measuring the position of the upper tool (11) of the press brake (6) in relation to the lower tool (12).

8. The method according to claim 1, characterized in that the robot (9) changes its grip from one gripping point to another when the sheet is in the grip between the tools (11, 12) of the press brake (6).

9. The method according to claim 1, characterized in that the first (101), second (102), third (-103) and fourth (104) steps of the method are taken in the numerical control (1000) of the press brake (6), or the like, and the fifth (105) and sixth (106) steps of the method are taken in the numerical controller (2000) of the robot or robots (9), or the like.

10. The method according to claim 1, characterized in that the degree of automation of the movement program (200) controlling the robot (9) is set by the operator.
